(19) United States
(12) Patent Application Publication
(10) Pub. No.: US 2005/0266378 A1
(43) Pub. Date: Dec. 1, 2005

(54) Two and three dimensional rubber dams configured for conventional and general field isolation by prior art and novel methods

(76) Inventor: John Heasley, Iowa City, IA (US)

Correspondence Address: John M. Heasley, 1614 Dover Street, Iowa City, IA, 52240, US

(21) Appl. No.: 11/194,639

(22) Filed: Aug. 2, 2005

Related U.S. Application Data
(63) Continuation-in-part of application No. 10/117,395, filed on Apr. 5, 2002.
(60) Provisional application No. 60/281,863, filed on Apr. 5, 2001.

(51) Int. Cl. A61C 5/14

(52) U.S. Cl. 433/136

(57) ABSTRACT

This application is a continuation-in-part of U.S. patent application Ser. No. 10/117,395, filed Apr. 5, 2002, which claims priority to Provisional Application Serial No. 60/281,863, filed Apr. 5, 2001. The application consists of three-dimensional rubber dams disclosed and presented in detail in the '395 filing and for which claims are pending since the filing of that application. This continuation-in-part, therefore, does not claim new material, but serves only to provide additional drawings of embodiments specified in that document. All of the criteria for the design of successful three-dimensional rubber dams of all types are included in the original document. In spite of the fact that graphic drawings were not entered into that parent document due to how lengthy the document had become by the date of filing, anyone skilled in the art, upon reading the criteria of design outlined, could visualize and construct any of the various types of three-dimensional dams specified in that document, whether three-dimensional dams with operative inserts or without operative inserts; or dams configured for conventional isolation or general field isolation or a hybrid type of isolation of both conventional and field isolation.

This application is a continuation-in-part of U.S. patent application Ser. No. 117,395, filed Apr. 5, 2002, which claims priority to Provisional Application Ser. No. 60/281,863, filed Apr. 5, 2001. Although these are the priority filing dates, the dates of conception and development precede these dates significantly. Claims for the three-dimensional rubber dams are pending from the Apr. 5, 2002 application.

In addition to the parent priority document U.S. Ser. No. 10/117,395 filed Apr. 5, 2002 cited above, another application, U.S. Ser. No. 10/728,100 filed Dec. 4, 2003, entitled Rubber Dams With Operative Insets and Integrally Attached External Frames Which Resist the External Vector Forces of Displacement and Effectively Isolate Dental Anatomical Structures of the Alveolar Arch, shows the general three-dimensional forms of rubber dams described in this application specifically applied to dams that have resilient operative inserts.

This continuation-in-part application presents embodiments of three-dimensional rubber dam forms that are disclosed in the text of my U.S. Ser. No. 10/117,395 application and for which claims are currently pending. The recitation for the design of these three-dimensional dam forms is confined to the text in U.S. Ser. No. 10/117,395. Due to how lengthy that document had already become, not every embodiment of dam was shown in the form of drawings. This application provides drawings where none were provided previously. It also shows innovative methods in which perforations may be efficiently prepared in dental rubber dams by a process of detachment of barrier membrane by controlled tearing. Although detailed descriptions of both two-dimensional and three-dimensional dental rubber dams were presented in the text of the '395 application, the drawings of three-dimensional rubber dams were left out of the original '395 application due to the large body of material already presented and due to how lengthy the document had already become. Recitation from the original text is cited as direct quotations to verify prior disclosure of these embodiments and the detailed rationale for the design of a forms of three-dimensional rubber dams forms is cited from that disclosure to organize it into a coherent presentation. The recitations quoted from the original '395 text are referenced with regard to page number and lines of text cited as an efficient reference to the lengthy parent document. Any new material that is presented as added novelty to dam forms already disclosed is explicitly identified as newly added material. In addition to the primary parent document, other continuation-in-part applications are pending that expand upon that original parent document. These other documents may be referenced if necessary in order to show other types of three-dimensional rubber dams presented in the Apr. 5, 2002 document. One continuation-in-part application that explicitly shows three-dimensional rubber dam forms, Ser. No. 10/728,100, is particularly helpful in displaying the general three-dimensional rubber dam forms.

All of the three-dimensional rubber dam forms are specifically disclosed in the text of the '395 application and are derived from the principles of design contained in that original text. Claims are already pending for three-dimensional rubber dam forms disclosed in that lengthy '395 application. After the publication date of that '395 document, anyone skilled in the art of dentistry who read the text of that application could ascertain the three-dimensional forms of dams disclosed without seeing drawings directly. The three-dimensional rubber dams disclosed are derived from the three-dimensional forms that the conventional flat rubber dam takes on when it is stretched into its operational contours when isolating various anatomical sites during dental treatment. In addition to this as the first criterion of design, vital features incorporating relevant anatomical features of the human oral cavity and the physiological and psychological needs of a patient undergoing dental treatment, as well as principles of engineering design and knowledge of contemporary methods of manufacturing, are incorporated into the final design of these three-dimensional rubber dams.

### BACKGROUND OF THE INVENTION

Summary of the Prior Art Attempts to Invent Three-dimensional Rubber Dams

### “Bags”! “Bag-Shaped”! “in the Shape of a Bag”! Bags! Bags! Bags!

Whether you cite Malmin's ‘fits like a glove’ “bag-shaped” drape, or Horvath's “bag-shaped” oral prophylactics, or Beat Kilcher's “bag-shaped” ‘top-hat’ form of whole arch dams that the inventor expects a patient to ‘swallow whole’ and breathe through his navel for an hour during a dental appointment, all of the prior art inventors have turned out crude “bag” technology that have been dysfunctional clinical flops and commercial failures. All of these inventors have thrown out the beneficial features of the 140 year-told prior art rubber conventional rubber dam in their attempt to eliminate the drawbacks of that original rubber dam device. It should have occurred to these inventors that any instrument or device that survives as being useful to a profession for 140 years must have a number of very valuable features that have made it successful enough to be of continued use to many members of that profession. That all of these inventors refer to their devices as “bags” is appropriately indicative of the lack of sophistication of their thought processes and the lack of their inventive ability.

Malmin, U.S. Pat. No. 5,078,604, Barrier Drape and Retainer Apparatus Thereof:

A prior art device cited in the prior art that is illustrative of the difference between a true rubber and the intra-oral barrier drape concept is U.S. Pat. No. 5,078,604, Barrier Drape and Retainer Apparatus Thereof, by Oscar Malmin. Although this device is a barrier device designed for dental usage, this inventor makes no pretensions about the device being a rubber dam, and instead describes it as a barrier drape, because it lies passively over the intraoral tissues in an attempt to avoid any stretching and the creation of internal stresses. The patent goes to great lengths to point out what are alleged to be the deficiencies of the rubber dam, foremost of which are the internal tensile stresses that the stretched membrane of the conventional rubber dam generates. The proposed-solution is a concave ‘bag shaped’ barrier drape which is pre-contoured to all of the anatomical irregularities of the oral cavity; a drape that lies passively over all of the tissues of the oral cavity and generates no internal stresses by stretching. Malmin proposes a technique of manufacturing into his barrier drapes projections on the membranes that can be cut with a scissors in order to automatically create holes in the barrier drape without the use of a rubber dam punch. His overall concept creates a floppy “bag-shaped” barrier device that is ‘stuffed’ so far back into the throat of a patient that it would be rejected instantaneously by any patient.

Horvath, EP1006925AI. Cofferdam

A second device illustrative of the difference between a true rubber dam and an intra-oral barrier drape, is a German device which purports to be a rubber dam (cofferdam in the German language), but really is a barrier drape in disguise and is described in European Patent No. EP 1006925AI (Horvath et al.). This is not a flat membrane, like a true rubber dam. Instead, it is described as “bag shaped” . . . “so that it fits easily into the oral cavity.” It is said to be “a rubber dam which is rolled up at its front end” . . . but by unrolling it, the . . . “bag-shape”of the dam can be protruded.” Effectively, the Accept is one of an oral prophylactic which comes from the factory rolled up like a condom, but after unrolling, a tubular or generally closed ended cylindrical membrane is exposed. The resultant membrane is then stuffed back into the oral cavity and throat of the patient in an attempt to provide a barrier. The problems with this concept are gagging and choking of the patient by excess membrane material, flopping around of the excess material by the actions of the patient's tongue, lack of retraction of the lips and cheeks, and a lack of the mouth being gently propped open by the membrane.

Beat Kilcher, U.S. patent application Ser. No. 10/393,119, Rubber Dam

A lengthy utility application was filed Apr. 5^{th}, 2002; Rubber Dams With Operative Inserts Which Isolate Anatomical Structures by Effectively Resisting the Exterior Vector Forces of Displacement, U.S. patent application Ser. No. 10/117,395 by John Heasley. This utility application was internationally publicized, and assigned a publication date of Oct. 17, 2002. That utility application claims priority to Provisional Application Ser. No. 60/291,862, filed Apr. 5^{th}, 2001. Five months after the official publication of this lengthy rubber dam manuscript, which describes the design criterion for construction of a variety of rubber dam devices, including three-dimensional rubber dams, application U.S. Ser. No. 10/393,119 was made public by another inventor that contained three-dimensional forms of rubber dams that parallel my specific instructions and criterion for the construction of 3-D dams contained in the text of my application:

The patent application entitled Rubber Dam, U.S. Ser. No. 10/393,119, filed internationally for the first time Mar. 20^{th}, 2003, five months after the publication of my U.S. patent application Ser. No. 10/117,395 claims the invention of a three-dimensional rubber dam form in U.S. Ser. No. 10/393,119, depicted as FIGS. 7,8,9, and 10 that I refer to in the text of my '395 application as a unilateral dam that is a rounded, truncated asymmetrical conical three-dimensional dam without an integrally attached external frame. The application refers to this dam as a “bag” and more specifically in general terms, a type of “bag” offset from the rim of the dam. Although that application refers to the rubber dam membrane as a “foil”, no recitation in the text refers to the dam being manufactured out of a malleable metal foil as an alternative material of construction. Quite the contrary, the word “foil” which has been translated from the German language, is qualified as “a rubber sheet” under detailed description of the invention, FIG. 2. The dam depicted has raised ‘cutoff’ projections or indentations) that are claimed to be novel but which have prior art predecessors. The projections are intended to be cut off with a scissors to form holes in the membrane without a rubber dam punch in a manner identical to projections in a prior art rubber dam, Malmin, U.S. Pat. No. 5,078,604. That dam also describes projections built-into a barrier dam that are intended to be cut off to form holes. These raised prior art projections are added to a three-dimensional rubber dam form that I previously disclosed, but the addition of the raised projections does not materially justify a claim of novelty over my disclosure. The form of dam I've disclosed has claims pending and is awaiting a patent grant. The Beat Kilcher application places great emphasis on a series of extremely detailed contour drawings of the dam as shown in FIGS. 7, 8, 9, and 10. This application makes a giant leap from “bag” technology to this very precise form of dam. Claim 5 and a related dependent claim 7 attempt to secure claims for this specific form of dam as generally an offset “bag” or an offset “circular bulge” dam. My '395 application did not include a graphic drawing of this embodiment of dam due to how lengthy the manuscript had already become, but anyone skilled in the art of dentistry who reads the text of my '395 application since it was made public can reconstruct the forms of three-dimensional rubber dams described, including the form of dam shown in FIGS. 7,8,9, & 10 of the Ser. No. #10/393,119 application, from my description and my rules for construction of three-dimensional dams. The correct geometric terminology for the dam in FIGS. 7, 8, 9, and 10 and the terminology that I use in my application is a rounded, truncated asymmetrical conical three-dimensional rubber dam without an integrally attached external frame. This dam's form is ultimately derived from the three-dimensional form of a conventional rubber dam stretched to its operational contours in a unilateral isolation application when a quadrant of teeth on one side of a patient's mouth is isolated. The resultant form of this type of unilateral dam can generally be described in slightly different terms of being generally an asymmetrical tapering shape such as a rounded, truncated conical dam or a rounded, truncated pyramidal dam or a rounded, truncated wedge form of dam or a rounded, or a truncated funnel form of dam with an axis that is deflected off-center from the frontal plane of the dam due to the fact that the dam accommodates the isolation of teeth on only one side of a patient's mouth. The truncated or generally flat or rounded the top of the truncated cone or alternative form (truncated means that a portion of the top of the cone is removed, leaving a plane at the top), forms a rear plane that compensates for the inter-occlusal height of the patient's mouth when it is in an opened position. Although I describe this dam in the text of my application in detailed geometric terminology, the application's reference to it as a “bag” or as an ‘off-center’ “bag”, is absurd. The author may have felt tied to the term “bag” because it is the only word that might give the appearance of a priority link to their past disclosures of “bags”. Dependent claim 7 modifying claim 5 attempts to link the term “circular bulge” to this dam form, although in the recitation of the text of the application, the term “circular bulge” refers to item 14, a thickening of the outer edge of the barrier membrane.

It should be noted that the degree of specificity of form of the dam of FIGS. 7,8,9, and 10 has, in addition to paralleling my previous disclosure, a design and intellectual sophistication that the authors of this patent application have consistently demonstrated that they don't have.

In addition to the introduction of a rubber dam embodiment that has the exact form that I describe in my '395 application, some basic features of design philosophy applied to rubber dam design that I recite have been abruptly adopted by the Ser. No. 10/393,119 application, signaling a discontinuity with past statements of inventive philosophy. This shift signals a radical departure from the approach of inventing “bag-shaped” forms of dams with no stretching or tension of the dam to stretching a rubber dam to an external frame, all in the same application. In my applications I have extolled the “benefits of stretching of the rubber dam because the tension in the dam beneficially retracts the patient's lips and cheeks and tongue, creates access for the clinician to the view the oral structures, draws excess barrier material out of the mouth thereby preventing gagging, creates a funnel shape for drainage of fluids to a focal spot for removal, and provides a gentle mouth propping action to keep a patient's mouth open”, Heasley, Pages 1 through 10. The abruptly new approach in the Ser. No. 10/393,119 application adopts the same philosophy of retraction. The application shows a frame (that incidentally resembles and functions in exactly the same capacity of my newly applied for United States Patent Application for Improved Rubber Dam Frames—minus one element that changes it ‘just a little bit’, that their three-dimensional rubber dam is to be stretched and attached to. This stretching duplicates my approach and creates internal tensile forces that will retract the lips and cheeks in exactly the same way that I recite, but contradicts their previous design philosophy.

It should be noted that although the author of Ser. No. 10/393,119 claims a priority date of Mar. 25, 2002, an examination of the foreign priority documents reveals that the dam shown in FIGS. 7, 8, 9, and 10 is missing from these documents. The claim of an international priority date of Mar. 25, 2002 for the asymmetric unilateral dam of FIGS. 7,8,9, & 10 as presented in the Ser. No. 10/393,119 application but not included in that Mar. 25, 2002 filing, cannot claim an international priority date of Mar. 25, 2002 for this dam over my Apr. 5, 2002 utility filing date. I have unequivocally described the dam shown in the context of a series of three-dimensional dams derived from the forms that a conventional rubber dam takes on when it is stretched to its operational contours in the mouth. Not only do I cite the form of this unilateral dam in the text of my '395 application, but I also have claims pending for this dam. At the current time, the assignee of application Ser. No. 10/393,119, Kerrhawe is marketing two rubber dams that correlate with my rubber dam descriptions: one dam is an anterior truncated pyramidal three-dimensional rubber dam without an integrally attached frame, and the other is a posterior-unilateral truncated asymmetric conical dam without an integrally attached frame. Both are to be stretched to an external frame. To view these, go to the Kerr web site, located wwwskerrdental.com, then go to menu option Products and click on A-Z List. Then go to the letter “O”, go down to OptiDam. The dams are not being advertised as “bags” as described in their application and do not in fact resemble “bags” at all. They are described in detail in my '395 application. The addition of ‘cut-off’ projections to the forms of dams I've presented does not materially affect a change of novelty of the dams that I've described. These projections are simply another way of cutting holes in a dam. In my '395 recitation, in addition to punching holes in rubber dams, I describe the act of “cutting” perforations also.

A detailed analysis of the application entitled Rubber Dam, Ser. No. 10/393,119, reveals the following: In FIG. 1 inter-proximal rubber 3 between teeth Z, nothing new or earth-shaking. FIG. 2 a flat membrane with 28 ‘cut-off’ projections. FIG. 5 and FIG. 6, show an ovoid cylindrical ‘top hat’ shaped dam. There is no hint of a tapering form at all. This form, with parallel sides, would not eject out of a mold or die, which would preclude it from some manufacturing processes, nor would it retract the patient's lips and cheeks laterally and posteriorly for good access to the facial and buccal surfaces of the teeth. The graphic drawing. FIG. 5 shows the dam from one side and FIG. 6 shows the same dam from the other side. On each side of the dam is a full arch of fourteen ‘cut-off’ projections labeled 6 on one side and 7 on the other side. The dam depicted is designed to isolate teeth all the way back to and including the posterior 2^{nd} molars with the closed end of the dam inserted far posteriorly into the mouth and the open end of the dam projecting forward. The presence of fourteen ‘cut-off’ projections indicates that the dam is planned for isolating a fill arch of teeth; from the central incisors to the second molars. The application says “ . . . projections for the entire jaw”. There is a large amount of rubber dam material left over behind the last molar projection that would be located so far back in the patient's mouth that it would go past the soft palate to the patient's throat. In fact, the application states: “ . . . the shape of the bag results in a largely tension-free adaptation of the bag in the pharynx, . . . . ” The pharynx, by the way, is the actual throat of the patient-past the hard palate, past the soft palate, and completely outside of the oral cavity. In other words, according to the author, the dam is supposed to be packed down the patient's throat. This dam, as depicted and instructed in its method of use, would cause a patient to gag, choke, sufficate, and die of asphyxiation, if it was not rejected by the patient immediately. In my recitations, I go over the fact that if a rubber dam apple is to be comfortable to the patient and a successful isolation device, it cannot violate the intra-alveolar space, which would cause it to impinge on the patient's tongue, soft palate, and throat. In my disclosure, I discuss the consequences of violation of the intra-alveolar space, which this dam violates. My rule of thumb is that a flat, closed ended bilateral three-dimensional rubber dam of arty type, should not be designed to extend any more posteriorly than ½ of the distance from front to back of the alveolar arch in order to be comfortable to the patient. Dams that are designed to isolate teeth anteriorly of this demarcation line are classified as anterior dams and isolate teeth in the front half of the mouth primarily (i.e. the front half of the alveolar arch). Posterior whole-arch dams should be designed with a concave inner diaphragm to make room for the patient's tongue, predictably allow for reflexive swallow movements, and to prevent impingement of the dam on the patient's soft palate, thereby avoiding the gagging response. (see my continuation-in-part application Ser. No. 10/728,100, FIG. 25b and FIG. 25c, and also 25d, and 25e with these inner central diaphragms labeled 17) in order to be predictably tolerated by the majority of the population. Of course, there are always exceptions to the rule when human beings are involved in a discussion, but these general rules-of-thumb for designing three-dimensional rubber dams have quite predictable results.

One drawback of pre-located ‘cut-out’ projections as depicted in FIGS. 5 and 6 is that the body of the three-dimensional rubber dam cannot be located independently of the holes provided. A clinician is ‘locked-in’ so-to-speak to accepting the locations of where the teeth must go through the dam, which in turn ‘locks’ the clinician into how the body of the dam must be located in the patient's mouth. This is a significant drawback of this type of approach because the body of the dam cannot be easily located in the mouth independently of where the teeth are to be drawn through the dam. The dam depicted in FIG. 5 and FIG. 6 would be dysfunctional clinically if it were used to isolate teeth all the way back to the second molar area.
(Heasley FIG. 3 and FIG. 8) “A whole arch bilateral three-dimensional dam with a flat posterior closed end must be equipped with a concave inner diaphragm 17 in order to be a functional dam”
(Heasley FIG. 1 and FIG. 6) “An anterior dam may either have a flat posterior closed end . . . ” (Heasley FIG. 2 and FIG. 7) “ . . . or alternatively may have a concave posterior closed end) and still be a functional dam”.

It should be noted that the form of the dam of FIGS. 7,8,9, and 10 has a degree of specificity and sophistication that the authors of this patent application consistently demonstrate that they don't have. The claim that FIGS. 7, 8, 9, and 10 specify a “bag-shaped” rubber dam is absurd. Any inventor that displays what he calls “bags” in one section of an application and then in the same application presents a sophisticated form that is a unilateral truncated asymmetric conical dam without an integrally attached fire in the same application should be viewed very suspiciously. It should be noted that claim 7, a dependent claim modifying claim 5, might inadvertently allow a claim for a three-dimensional form of dam that is a “semi-circular bulge” to be accepted, when the term in the text for “semi-circular bulge” refers to #14, is a thickness of the membrane located around the perimeter of the flat oval membrane.

The Beat Kilcher application entitled Rubber Dam, as filed on Mar. 25, 2002 in Switzerland discloses only FIGS. 1-6 of the drawings and discusses only the embodiments of FIG. 14 in its text. The form of the dam in drawings, FIG. 7, 8, 9, 10 is missing in that application, as are FIGS. 11a-c, 12a-c, and 13, and 14 disclosing a “U” or “C” shaped rubber dam frame are also missing from the application filed on Mar. 25, 2002. The newer Kilcher Rubber Dam application filed as U.S. Ser. No. 10/393,119, on Mar. 20, 2003 that does contain the unilateral rubber dam, was filed five months after the publication of my utility application U.S. Ser. No. 10/117,395 that was filed Apr. 5, 2002, and publicized on Oct. 17, 2002. Anyone could read the explicit instructions given in that '395 document and reconstruct the three dimensional rubber dams disclosed, including the unilateral rubber dam form that Kerrhawe belatedly now claims as its own.

So in summary, the U.S. Ser. No. 10/393,119 application modifies a rubber dam form that I describe in the text of my '395 application, ‘just a little bit’; modifies a Same that I describe in my US Improved Frames application ‘just a little bit’, submits International Priority Documents that do not support their claim to an international priority date of Mar. 25, 2002 for the dam depicted in FIGS. 7,8,9, & 10, and then does not provide a translation that an examiner can read for verification. The application creates a focus of the inventive novelty being claimed as raised “cut-off” projections, so that the disclosure statement submitted will appear to be sufficiently provided if a few references to this specific feature are listed. This absolves the applicant from the need to provide a disclosure statement pertaining to new forms of three-dimensional rubber dams, one of which the applicant has “inadvertently?” failed to mention that an earlier inventor has just submitted in a lengthy document describing novel rubber dam forms. The creation of a selective focus that diverts an examiner's attention away from a detailed three-dimensional rubber dam form that is neither a “bag” nor a “circular bulge” and is buried within the context of a pretense of alternative novelty is the sole creative aspect of this application.

### Heasley's

### Three-dimensional Rubber Dams Designed From Forms Derived From the Conventional Rubber Dam Stretched to its Operational Contours in the Mouth

The following continuation-in-part application presents drawings of three-dimensional rubber dams that I specified in the written text of my U.S. Ser. No. 117,395 application. These three-dimensional rubber dams are designed according to a number of principles that make them efficacious clinically as described. Recitations from that '395 application describe three-dimensional rubber dams constructed with or without operative inserts that are configured for conventional, general field, or hybrid isolation of teeth and soft tissues and that may be constructed of the full range of materials mentioned in the parent application. Although most dams depicted in this disclosure are conventionally configured with individual holes, any one of these same dams may alternatively be configured with slits for general field isolation or holes and slits for hybrid isolation or alternatively have solid membranes that can be customized by the end-user

### Rational For Design of Three-Dimensional Rubber Dams

### Design Criterion Number One

The rationale for the design of three-dimensional rubber dams is based directly on the three-dimensional forms of the conventional rubber dam stretched to its operational contours in the mouth of a patient.

Three-dimensional rubber dam forms are derived from the Conventional Rubber Dam Stretched to its Operational Contours in the Mouth of a Patient for a Particular Type of Isolation

Heasley, Page 2, Lines 3-5:

“The dental rubber dam is generally a flat sheet of resilient material, which changes in shape to its operational contours by an active interaction with the tissues that it is stretch over”

Heasley, Page 1, Lines 22-23:

The rubber dam devices described in this patent disclosure are the direct descendants of the prior art of operational site isolation with the rubber dam

Heasley Page 1, Lines 29-32”

“ . . . the dental rubber dam is actively stretched over anatomical structures, thereby creating internal tensile stresses which interact with and serve to actively retract anatomical soft tissues.”

The end-form of the conventional rubber dam stretched to its operational contours for a specific type of clinical isolation is the first criterion for the generalized form of any three-dimensional rubber dam. The final rubber dam form, dimensions and proportions are derived from practical clinical applications of the prior art conventional rubber dam. Obviously, since patients vary significantly in size and proportion, the mathematical values incorporated into commercially available three-dimensional rubber dams are derived from a generalized cross-section of applications in actual clinical practice.

Since conventional rubber dams are used to isolate different sections of the alveolar arch at a time, such as anterior segments, the anterior half arch, posterior segments or quadrants of teeth simultaneously, or a single tooth individually in any location, whether an upper maxillary or lower mandibular tooth, the conventional rubber dam takes on a variety of three-dimensional end-forms after stretching it to its operational contours.

Heasley, Page 8, Line 10-13:

“The resultant form of the three dimensionally stretched unilaterally retained field isolation rubber dam is roughly an irregular pyramidal shape, which interacts with the intra-alveolar space in a generally acceptable manner.

Heasley Page 2. Lines 14-17:

“ . . . [stretching the dam to an] external framework, creates a funnel-shaped configuration, which, when the patient is in the supine position as all modern dental procedures are performed, actively directs the drainage and flow of fluids to a focal point, where an assistant can suction them out of the operative field.”

While whole arch isolation is a rarity, the general contours required to isolate a whole arch are based on extrapolation from the operational contours of the rubber dam when isolating teeth in other circumstances and also the inventor's clinically derived data of successfully applied whole-arch rubber dam forms.

Heasley: Page 45, Lines 2-5

“ . . . the rubber dam appliance must be molded on a three-dimensional die or molding element which is either a generally rounded wedge shape or a generally rounded pyramidal form or a generally rounded conical form . . . ”

### Design Criterion Rule Two

### The Three-Dimensional Rubber Dam Must Preserve the Beneficial Features Of the Conventional Rubber Dam as Criterion for Design

In my applications I have extolled the “benefits of stretching of the rubber dam because (a) the tension in the dam beneficially retracts the patient's lips and cheeks and tongue, (b) creates access for the clinician to the view the oral structures, (c) draws excess barrier material out of the mouth thereby preventing gagging, (d) creates a funnel shape for drainage of fluids to a focal spot for removal, (e) and provides a gentle mouth propping action to keep a patient's mouth open”

Heasley Page 2, Line 3-5

“ . . . The rubber dam is generally a flat sheet of resilient material which changes in shape to its operational contours by an active interaction with the tissues that it is stretched over . . . ”

Heasley's improved rubber dam devices retract the tongue through tensile forces of the stretched membrane. In addition, the improved rubber dam devices retract the lips and cheeks through tensile forces of the stretched membrane, in the same manner in which the prior art rubber dam utilizes tensile forces of the stretched membrane for these beneficial purposes.

Heasley Page 2, Lines 22-25

“ . . . Finally, the stretching of the rubber dam over an external framework creates internal tensile stresses, which retract the patient's lips, tongue, and cheeks, thereby exposing the operative site for maximal access for instrumentation.”

Benefits and Characteristics of Stretching the Dam to an External Frame:

Heasley's improved rubber dams recite the usefulness of stretching the rubber dam to standardized prior art rubber dam frames:

Heasley Page 2, Lines 14-17: Control of Fluids:

“(stretching the dam to an) external framework, creates a funnel-shaped configuration, which, when the patient is in the supine position as all modern dental procedures are performed, actively directs the drainage and flow of fluids to a focal point, where an assistant can suction them out of the operative field.”

Heasley Page 2, Line 19-22, Mouth Propping Action:

“The tensile forces created by the stretching of the rubber dam gently coax the patient into keeping his mouth open during the process of reflexive swallowing during a procedure, thereby exposing the operative site for maximal access for instrumentation.”

Heasley, Retraction of Lips, Cheeks, and Tongue

“improved flat-plane rubber dams, are stretched to a framework outside of the mouth and utilize tensile forces of the stretched membrane to retract the lips, cheeks, and tongue”

Heasley Page 2, Lines 7-10.

Stretched membrane beneficially diverts excess membrane material out of the mouth by stretching it to an external frame.

“ . . . The actively stretched rubber dam takes up all the excess material of the rubber dam membrane, diverting it to the outside of the mouth wherever possible, so that it does not obstruct the tongue and throat of the patient.”

The conventional rubber dam membrane, particularly in applications where a posterior quadrant is being isolated, but also in other applications as well, stretches to the general configuration of a funnel. Whether one defines the end-shape of the rubber dam in this configuration as a generally rounded conical form or a truncated conical form or a generally rounded, truncated conical form or alternatively as a more rectilinear truncated pyramidal form, or a truncated funnel shape or other tapering forms that preserve the actions of conventional rubber dam practically applied to a given anatomical site, these differences are primarily semantic and represent inconsequential geometric alternatives as a means to achieve the same end result. As a practical example of comparisons of alternative forms, if a funnel-shaped, generally rounded conical form or a funnel-shaped truncated pyramidal form diverts fluids during a dental procedure to a common location where they can be suctioned up by auxillary personnel when a patient is in a supine position, the slight geometric difference in form of dams is a negligible variable. In addition, the generalized form of the manufactured end-product dam will be modified somewhat by an interaction with the tissues of each individual's anatomy in the same way but of a lesser degree than its related exemplary predecessor. The end-result achieved is modeled on the relationship established when a conventional rubber dam is applied and a patient is in a supine position as modern dentistry is practiced The three-dimensional rubber dam form is modeled after the shape that the conventional rubber dam takes on when it is stretched to its practical isolation contours during dental treatment.

Generally speaking, if the application is a bilateral isolation application, the general form of the three-dimensional rubber damn will be symmetrical about a plane that is coincidental to the mid-saggital plane of the patient when the dam is in place in the patient's mouth. In this case, the central axis of the general form of the body of the dam will be disposed perpendicularly to the frontal plane of the dam.

If the application is a unilateral isolation application, the general form of the three-dimensional rubber dam will be asymmetrical about a plane that is coincidental to the mid-saggital plane of the patient when the dam is in place in the patient's mouth. In this case, the central axis of the general form of the body of the dam will not be disposed perpendicularly to the frontal plane of the dam but will be asymmetrically displaced with respect to this frontal plane of the dam.

The preservation of stretching of the three-dimensional rubber dam mimics the beneficial effect of the stretching of a conventional rubber dam. In the case of a three dimensional rubber dam without an integrally applied frame, the circumstance is slightly different, however, in that the three-dimensional form allows the rubber dam to be placed and secured in the mouth more easily since the cavitation of an applied dam is already anticipated in the manufactured form. The ‘loading’ of tensile forces, which serve to beneficially retract the lips, cheeks, and tongue, and also serves as a gentle mouth propping action, takes place after the dam has been anchored in the mouth and stretched and anchored to the frame, if the particular dam is an elastomeric dam with a relatively high percentage of elongation and modulus of elasticity. If the three-dimensional rubber dam has an integrally attached exterior frame, however, the dam must be manufactured with a cavitation somewhat less than the dimensions of the oral cavity to be isolated an the clinician must be more experienced in anticipating the correct size of dam that will balance elongation and stretching of the dam with the dimensions of the patient's anatomy and the resistance of the surrounding soft tissues. Alternatively, if the dam is not made of an elastomer and is a malleable dam or an alternative material with a low percentage of elongation, the degree of plasticity of the material and the forces generated by the deflection of the material will materially affect its ability to deflect tissues properly. While a slightly different mechanism is involved, if the calculated end-result is the same, the application will be successful.

### Design Criterion Number 3

### Rubber Dam Appliance Must Not Cause a Patient to Gag, Choke, or Reject the Dam

Nature has imbued the human being with certain defense mechanisms to protect itself as an organism. For this reason, some areas of the oral cavity cannot be encroached upon. This is particularly true in the back of a patient's mouth where the soft palate meets the hard palate, because this is the locus of the patient's gag-response, which is the body's physiological attempt to prevent excessive foreign material from being forced down a patient's throat. The ‘gag-response’, a feeling of choking, of claustrophobia, and of suffication are some relevant terms for untoward encroachment upon the physiological defenses of the human organism when its physiological needs are threatened. These traits are shared among mammals other than the human, also.

Heasley invents the term intra-alveolar space to anatomically define an area of intra-oral anatomy where an isolation device may not intolerably violate the oral cavity without rejection by the patient:

Heasley: if whole arch isolation is to be attempted, the integrity of the patient's interior oral cavity structures, such as the tongue an periodic swallowing reflexes (must be respected).”

Heasley Page 5, Lines 27-29.

“This means that the dam must preserve the “intra-alveolar space”

Heasley page 6, line 23“. . . the posterior boundary of this (space) is the soft palate, . . . this is the locus of the patient's gag reflex. Any device which . . . violates the intra-alveolar space is doomed to failure clinically and commercially, because it will not be tolerated by the patient. The result will be discomfort to the patient, gagging and choking, a constant interruption of the clinical procedure, and ultimately a failure of the device clinically.”

Heasley Page 6, Line 23 to Page 7, line 4. See Heasley's FIGS. 29a and 29b showing a specialized rubber dam with a concavity to prevent encroachment upon the intra-alveolar space during whole arch isolation.

Heasley Page 6, line 31 to Page 7, line 2 “Any device which . . . violates the intra-alveolar space is doomed to failure clinically and commercially, because it will not be tolerated by the patient. The result will be discomfort to the patient, gagging and choking, a constant interruption of the clinical procedure, and ultimately a failure of the device clinically.”

### Design Criterion Number 4

### The Three-Dimensional Dam must be Designed Appropriately for a Recurring and Useful Clinical Isolation Need

### 95% of the Time Dentists Require Isolation of Only a Portion of an Alveolar Arch

Dentists almost always work on only a portion of a single arch, far less frequently on an -upper and lower segment or quadrant at a time, rarely on a whole arch at a time unless the application is for orthodontic purposes, which typically involves a whole arch at a time.

Typical dental treatment operating sites are an anterior segment (front teeth) or a quadrant, which is ½ of an arch or all of the teeth on one side of a patient's mouth in a single arch. Of the 1.3 billion dental procedures performed in the U.S. per year, most were performed by a dentist only isolating a portion of an alveolar arch at a time, not a full alveolar arch, unless the application is for orthodontic purposes

### Various Shaves and Forms of Molds, Dies, Mandrels and Dams

Heasley; Page 45, Lines 2-5

“ . . . rubber dam appliance must be molded on a three-dimensional die or molding element which is either a generally rounded wedge shape or a generally rounded pyramidal form, or a generally rounded conical form, . . . ”

Heasley; Page 44, Line 29-Page 45, Line 6

“The design of a reciprocal rubber dam appliance to isolate an entire alveolar arch of teeth by reciprocal forces must describe a three dimensional solution to the three-dimensional requirements of the oral cavity in this circumstance. For this reason, a flat-plane rubber dam membrane cannot satisfy the requirements placed upon it in this isolation circumstance. Instead, the reciprocal whole-arch rubber dam appliance must be molded on a three-dimensional die or molding element which is either a generally rounded wedge shape or a generally rounded pyramidal form, or a generally rounded conical form, with a centrally located concavity for forming a concave interior diaphragm relieving the impingement of excess rubber dam material in the patient's interior oral cavity.”

### Manufacturing Requirements of Three-Dimensional Dams

There are a number and variety of methods of manufacture of three-dimensional rubber dams, from injection molding to overmolding, to thermoplastic molding, to dip molding, to stamping malleable metal with dies, etc. One general rule of making either a mold or forming with a die is that the dam have a certain amount of divergence toward the wider or open portion of the dam. This is so that the mold cavity can be opened and the molded piece ejected from the mold or the die separated an the formed dam ejected from the die. For this reason, a generally conical or pyramidal wedge or tapering form of some kind, even a tapering bag form is required. If the lateral surfaces of any of these alternative forms were traced to a focus point where they converge, the forms would in part be defined by the mathematical distance from a point on the form or within the mass of the form to its focal point. Of course, if the surfaces never converged, the surfaces would be parallel and there wouldn't be a calculable focal point other than a reference to infinity. Of significant importance is whether the three-dimensional dam has operative inserts attached to or imbedded within the membrane. Techniques such as overmolding are useful in the manufacturing of these devices, while dams that do not have operative inserts (see discussion Heasley Ser. No. 10/117,395; Page 28, lines 17-21 and lines 23-26. See also related application-Heasley: General Field Isolation Rubber Dams Without Operative Inserts) may be directly injection molded if made of elastomeric polymers or alternatively stamped and formed if they are of malleable foil composition.

### Three-Dimensional Rubber Dams that Isolate Alternative Portions of the Oral Cavity

### The Anterior Three-Dimensional Rubber Dam that Isolates Either the Anterior Segment or the Anterior Half of the Alveolar Arch

Heasley, page 41, line 9-15: “The . . . isolation of the anterior segment or the anterior half arch may be manufactured in a flat form without the type of diaphragm that the reciprocal whole arch . . . rubber dam requires. This is because the application is confined to a much more anterior location in the oral cavity, still allowing room for the patient's tongue and not encroaching upon the interior oral cavity to the degree that the whole arch application does. With placement of the anterior dam out of reach of areas where the gag reflex is triggered, the patient is able to tolerate the intrusion of the rubber dam.”

Heasley, Page 41, line 15-21 “Although the anterior resilient inter-arch rubber dam may be manufactured in a flat form, it also may be manufactured on a three dimensional die, . . . . As previously mentioned, no “cut-out” concavity needs to be fabricated into this dam, but it is not inconceivable that some clinicians might prefer this alternative embodiment.”

Heasley: Page 7:lines 20-27 “A whole arch isolation technique that goes way back into the space must have the concave diaphragm, but an isolation device which only seeks to isolate the anterior half of the alveolar arch generally will afford the patient enough space within the intra-alveolar space to accommodate his tongue and also will avoid the reflexive gag response. All people are quite individual, however, so individual variability will have an overall effect. The anterior half arch field isolation rubber dam, for the reasons stated, may be commercially fabricated without an inner concave diaphragm and still be a clinically efficacious modality of field isolation. Of course, this same dam could also be fabricated with an interior concave diaphragm.”

### The Wedge Shaped Dam

Applied to Isolation if a Bilateral Arch Segment:

The wedge shaped dam can replicate the general form of a conventional rubber dam when a bilateral arch portion is isolated. With this three-dimensional form oriented so that it's plane of symmetry is coincidental with the patients mid-saggital plane when the dam is in the mouth, one side of the ‘V’ shape of the wedge isolates the teeth involved in the application, while the other diverging side of the form opens toward the front of the mouth to give access to the site. See FIG. 5 and FIG. 10

Applied to Isolation of Two Opposing Posterior Segments or Quadrants:

If the wedge shaped three-dimensional dam is turned 90 degrees so that it is disposed asymmetrically with respect to the frontal plane of the dam, this form can also be useful for isolating two opposing posterior segments or quadrants simultaneously. In this case, the two quadrants are isolated on the opposing sides of the wedge shape that are more nearly parallel that the more divergent sides, that open toward the front of the mouth to give access to the site. This orientation not shown in graphic drawings.

### The Unilateral Three-Dimensional Rubber Dam

The form of the unilateral three-dimensional rubber dam is derived directly from the form of a conventional rubber am, stretched to its operational contours when isolating a quadrant of teeth on one side of a patient's mouth.

This resultant form can generally be described in terms of the body of the dam taking on an asymmetric generally rounded, truncated tapering form that is asymmetrically disposed laterally in relation to a vertical plane in the center of the rubber dam which is coincidental with the mid-saggital plane of the patient's midline when the dam is in place in the patient's mouth. The body of the dam can also be described as being asymmetric-ally disposed to the frontal plane of the dam; the frontal plane being perpendicular to the patient's mid-saggital plane when the dam is in place in the mouth of the patient. Whether the dam is also concurrently asymmetrically disposed with respect to a horizontal plane intersecting the vertical midline plane at the same time, depends ultimately on the specific design of the type of unilateral dam.

The term “asymmetric generally rounded, tapering form of some kind”, quoted above is generally accurate with respect to describing the forms of these unilateral dams, but more specific terminology is that these dams can be manufactured as either unilateral, truncated pyramidal forms or unilateral, truncated conical forms or asymmetrical truncated semi-circular rounded forms or asymmetrical, truncated tapering wedge forms, or asymmetrical truncated funnel forms, or a composite form comprising mixed features of the previously described tapering forms.

The unilateral three-dimensional dam is always an asymmetrical dam, if viewed from at least one side orthographic projection view and can, in some cases, depending on the type of three-dimensional rubber dam being described, may also be asymmetrically disposed with respect to a horizontal axis. In other words, there can be some variability, although the parameters of variability are limited by the functionality of the final form as a unilateral isolation dam.

If the dam has an integrally attached external frame, the frame is located in generally the same plane coincidental with the frontal plane of the dam when it is in place in the mouth. This integral frame may comprise a circular rim around the dam or an oval or elliptical or square or rectangular or other form around the circumference of the dam. Alternatively if the dam is without an integrally attached fame but attaches to a frame that is a separate device, the frontal planar rubber dam membrane and the frame that is a separate device that it is stretched over, occupy the same location and relationship to the axis of the general tapering form of the dam as the integrally attached frame. This is true whether the shape of the dam is generally conical, funnel shaped, pyramidal, tapering wedge, semi-circular tapering, or alternatively a composite of the other tapering forms presented. If the dam is a unilateral dam, it is disposed asymmetrically with respect to the center of the frontal plane defined by the frame forming a rim around the dam with the axis of the general tapering form non-perpendicularly disposed to the frontal frame, rim, or plane of the dam.

Heasley: Page 7; lines 5-9 “The unilateral general field isolation rubber dams do not pose the same problems of intolerable intrusion into the intra-alveolar space that the whole arch reciprocally retained field isolation appliances do. The reason for this is that isolation is only on one side of the mouth, and the action of the rubber dam frame in stretching the excess rubber dam material draws the excess material out of the alveolar space, creating room for the tongue and internal structures to be accommodated.”

Heasley: Page 23, Lines 22-Page 24, Line 22

“The use of the rubber dam in isolating a posterior segment or quadrant of teeth for treatment is the most challenging application of the rubber dam. The dam must be stretched to its maximal extension beyond the plane of the rubber dam frame to reach a single most posterior molar which has been clamped with a rubber dam clamp.” . . . “ . . . a single rubber dam clamp resisting the summation of tensile forces converging toward the single point of maximal flexure.”

Heasley: Page 7 Lines 10-12

“The resultant form of the three dimensionally stretched unilaterally retained field isolation rubber dam is roughly an irregular pyramidal shape, which interacts with the intra-alveolar space in a generally acceptable manner.”

Heasley Page 2, Lines 14-17: Control of Fluids:

“ . . . [stretching the dam to an] external framework, creates a funnel-shaped configuration, which, when the patient is in the supine position as all modern dental procedures are performed, actively directs the drainage and flow of fluids to a focal point, where an assistant can suction them out of the operative field.”

### Whole Arch Isolation with the Three-Dimensional Rubber Dam

Heasley; Page 44, Lines 29-Page 45, Line 6

The design of a reciprocal rubber dam appliance to isolate an entire alveolar arch of teeth by reciprocal forces must describe a three dimensional solution to the three-dimensional requirements of the oral cavity in this circumstance. For this reason, a flat-plane rubber dam membrane cannot satisfy the requirements placed upon it in this isolation circumstance. Instead, the reciprocal whole-arch rubber dam appliance must be molded on a three-dimensional die or molding element which is either a generally rounded wedge shape or a generally rounded pyramidal form, or a generally rounded conical form, with a centrally located concavity for forming a concave interior diaphragm relieving the impingement of excess rubber dam material in the patient's interior oral cavity.

Heasley Page 7; Lines 20-21

“A whole arch isolation technique that goes way back into the [intra-alveolar] space must have the concave diaphragm”

### Configuring the Three-dimensional Rubber Dam for Alternative Forms of Isolation

A Three-dimensional rubber dam may be manufactured with a slit or a series of holes integrally prepared in the membrane at the time of manufacture. Alternatively, if the dam does not have any holes or slits or mechanisms for the creation of holes or slits, a solid membrane dam may be manufactured and the end-user may configure it as needed. The end user may punch, cut, or otherwise prepare a series of individual holes for the conventional method of application of a rubber dam; or a slit for general field isolation may be punched, cut, or otherwise configured for general field isolation, or both holes and a slit may be punched, cut, or otherwise configured in a hybrid application of conventional and field isolation simultaneously. Although the rubber dam punch has been the mainstay of punching holes in a rubber dam, other methods reported in the prior art literature, such as producing a dam with a series of projections that are cut off such as presented by Malmin in U.S. Pat. No. 5,078,604, or manufacturing the dam with open holes already prepared in the dam has been reported in the prior art literature and may be manufactured into the dam.

Heasley Page 49, lines 5-6: “Embodiments of the Invention Applicable to Improvements in Conventional Rubber Dam Isolation Techniques”

Heasley, Page 49, Lines 16-21:

“The conventional technique of rubber dam usage consists of the clinician punching a series of holes in a rubber dam membrane which correspond to the teeth which the clinician plans on isolating, then pulling the rubber dam membrane over each tooth, sequentially exposing them on the opposite side of the membrane for clinical access for instrumentation.”

Heasley, Page 21, Line 9-11:

“ . . . the clinician has a choice of cutting a slit in the inner area of the membrane or by punching holes for the isolation of individual teeth and then also punching or cutting a slit for select teeth to be field isolated”.

Heasley; Page 18, Lines 12-13

“FIG. 25 is a plan view of a general field isolation dam with holes punched in it for use in a technique that is a hybrid of the present invention and conventional rubber dam techniques”

Heasley, Page 21, Line 31 to Page 22, Line 2

“a solid interior membrane which is prepared by the clinician for the hybrid approach of isolating some teeth through holes and other teeth that are scheduled for field isolation by preparing a slit”

### The Three-Dimensional, Fully Contourable Rubber Dam with a Mesh or Solid Planar Malleable Operative Insert

The three-dimensional, fully contourable rubber dam with a mesh or solid planar malleable insert is an extension of the concept of the insertion of an operative insert, but instead of a wire or a metal stamping located somewhere in the membrane, the insert is either a solid sheet of malleable material or a malleable type of mesh material, interposed between exterior sheets of polymeric material. (Note: if malleable material without the exterior layers of polymeric material is substituted, this alternative embodiment should be considered to be within the scope and spirit of this disclosure). The sheet of malleable material allows the three-dimensional dam to be more accurately contoured in a similar manner as the action of a foil. The malleable material allows the dam to retain the memory of the configuration that the clinician molds it into in order to satisfy his procedural requirements.

### Advances in Clinical Isolation Methods with Three-dimensional Rubber Dams

An anterior three-dimensional rubber dam lends itself to isolation of a single anterior segment of teeth, or alternatively isolation of the opposing anterior segment, or both the maxillary and mandibular segments simultaneously. This novel feature of isolating both the upper and lower anterior segments simultaneously is ideal for bleaching procedures, where the gingival tissues may be protected from caustic chemicals.

Posteriorly, a unilateral three-dimensional rubber dam has the same versatility. It also may either isolate an upper quadrant of segment or alternatively the segment or quadrant in the reciprocal ach or both the upper and lower opposing segments or quadrants simultaneously.

### A BRIEF SUMMARY OF THE DRAWINGS

FIG. 1 generally at 101 is an anterior truncated pyramidal three-dimensional rubber dam with a flat posterior inter-arch-surface 20 and without an integral external frame attached to the outside of the dam

FIG. 2 generally at 102 is an anterior truncated pyramidal three-dimensional rubber dam with a central concave diaphragm 17 in the middle of the posterior inter-arch surface 20 to prevent impingement of the dam and without an integral external frame attached to the outside of the dam

FIG. 3 generally at 103 is a posterior truncated pyramidal three-dimensional rubber dam with a central concave diaphragm 17 in the center of the posterior inter-arch surface 20 to prevent impingement of the dam on the patient's throat. This dam does not have an integral external frame attached to the outside of the dam

FIG. 4 generally at 104 is a unilateral truncated asymmetrical conical three-dimensional rubber dam without an integral external frame attached

FIG. 5 generally at 105 is a unilateral truncated asymmetrical wedge-shaped three-dimensional rubber dam without an integral external frame attached

FIG. 6 generally at 201 is an anterior truncated pyramidal three-dimensional rubber dam with a flat posterior inter-arch surface 20 without an integral external frame attached to the outside of the dam

FIG. 7 generally at 202 is an anterior truncated pyramidal three-dimensional rubber dam with a central concave diaphragm 17 in the posterior inter-arch surface to prevent impingement of the dam with an integral external frame attached to the outside of the dam

FIG. 8 generally at 203 is a posterior truncated pyramidal three-dimensional rubber dam with a central concave diaphragm 17 in the posterior inter-arch surface to prevent impingement of the dam on the patient's throat with an integral external frame attached to the outside of the dam

FIG. 9 generally at 204 is a unilateral truncated asymmetrical conical three-dimensional rubber dam with an integral external frame attached to the outside of the dam

FIG. 10 generally at 205 is a unilateral truncated asymmetrical wedge-shaped three-dimensional rubber dam with an integral external frame attached to the outside of the dam

FIG. 11 graphically shows a side view of the embodiment of dam shown in FIG. 4, generally at 104 of a three-dimensional rubber dam configured with individual holes for conventional isolation of individual teeth

FIG. 12 graphically shows an end view of the embodiment of dam shown in FIG. 4, generally at 104 of the three-dimensional rubber dam configured with individual holes for conventional isolation of individual teeth

FIG. 13 graphically shows a top view of the embodiment of dam shown in FIG. 4, generally at 104 of the three-dimensional rubber dam configured with individual holes for conventional isolation of individual teeth from a top view

FIG. 14 graphically shows an isometric view of FIG. 4, the three-dimensional dam generally at 104 configured with individual holes for conventional isolation of individual teeth

FIG. 15a generally at 204 is a unilateral truncated asymmetrical conical three-dimensional rubber dam configured with individual holes for conventional isolation of individual teeth

FIG. 15b generally at 204 is a unilateral truncated asymmetrical conical three-dimensional rubber dam configured with a slit for general field isolation of a group of teeth and/or soft tissues

FIG. 15c generally at 204 is a unilateral truncated asymmetrical conical three-dimensional rubber dam configured with individual holes and a slit for a hybrid form of isolation of both individual teeth and isolation of a group of teeth and/or soft tissues simultaneously

FIG. 15d generally at 204 is a unilateral truncated asymmetrical conical three-dimensional rubber dam with a solid unperforated membrane for the end-user to custom configure as required by the type of isolation to be undertaken

FIG. 15e generally at 204 is a unilateral truncated asymmetrical conical three-dimensional rubber dam configured with a raised projection slit for general field isolation of a group of teeth and/or soft tissues simultaneously

FIG. 15f generally at 204 is a unilateral truncated asymmetrical conical three-dimensional rubber dam configured with raised individual projections for conventional isolation of individual teeth

FIG. 16 shows a novel method of removing an elongated slit-like section of a rubber dam membrane by controlled tearing along a recessed indentation called a tear line, formed around the elongated slit in the membrane at the time of manufacture of the rubber dam

FIG. 17 shows a novel method of removing circular pieces of a rubber dam membrane by controlled tearing along a recessed indentation called a tear line, formed around the circular piece of membrane at the time of manufacture of the rubber dam

FIG. 18 shows a novel method of removing a circular raised projection of a rubber dam membrane by tearing along the recessed indentation tear line that has been manufactured in the rubber dam

FIG. 19 shows a sectional view AA of FIG. 17 of the recessed indentations around a flat piece of rubber dam membrane

FIG. 20 shows a sectional view BB of FIG. 18 of the recessed indentations around a raised piece of rubber dam membrane

FIG. 21 shows a three-dimensional rubber dam generally at 301 that has an operative insert generally at 14 to help hold the dam in place. This dam is shown isolating a maxillary anterior segment of teeth

FIG. 22 shows a three-dimensional rubber dam generally at 201 isolating a mandibular anterior segment of teeth

FIG. 23 shows a three-dimensional rubber dam generally at 201 isolating both a maxillary and mandibular anterior segments of teeth

FIG. 24 shows the same dam as in FIG. 21, a three-dimensional rubber dam generally at 301 that has an operative insert generally at 14 to help hold the dam in place. This dam is shown isolating both maxillary and mandibular anterior segments of teeth

FIG. 25 shows a flat dam configured for anterior bilateral isolation generally at 401 that has individual raised projections 70c that may be detached from the rubber dam membrane by controlled tearing along a tear line to form holes in the rubber dam membrane for individual teeth to be isolated

FIG. 26 shows a flat dam configured for posterior unilateral isolation generally at 402 that has individual raised projections 70c that may be detached from the rubber dam membrane by controlled tearing along a tear line to form holes in the rubber dam membrane for individual teeth to be isolated

FIG. 27 shows a flat dam configured for anterior bilateral isolation generally at 403 with an operative insert generally at 14 that has both individual raised projections 70c and a raised slit projection 18b that may be detached from the rubber damn membrane by controlled tearing along a tear line to form both individual holes in the membrane and a slit for hybrid isolation

FIG. 28 shows a flat dam configured for posterior unilateral isolation generally at 404 that has a raised slit projection 18b that may be detached from the rubber dam membrane by controlled tearing along a tear line to form a slit in the rubber dam membrane for general field isolation

FIG. 29 shows the prior art method of punching holes in a rubber dam with a rubber dam punch

FIG. 30 shows the prior art method of cutting off projections on a rubber dam membrane in order to form holes in the rubber dam

### APPLICATIONS OF EMBODIMENTS OF THREE-DIMENSIONAL RUBBER DAMS

(Please note: Although many dams are depicted with individual holes prepared 70 for conventional isolation, this is arbitrary. Any of the dams presented can alternatively be shown with a slit 18 for general field isolation or both holes 70 and a slit 18 for a hybrid type of isolation, or solid membranes, or dams with raised circular or slit projections to allow customization by the end-user. Whether a dam has a flat, solid membrane or raised projections of any type, these variations are all considered an unperforated membrane.

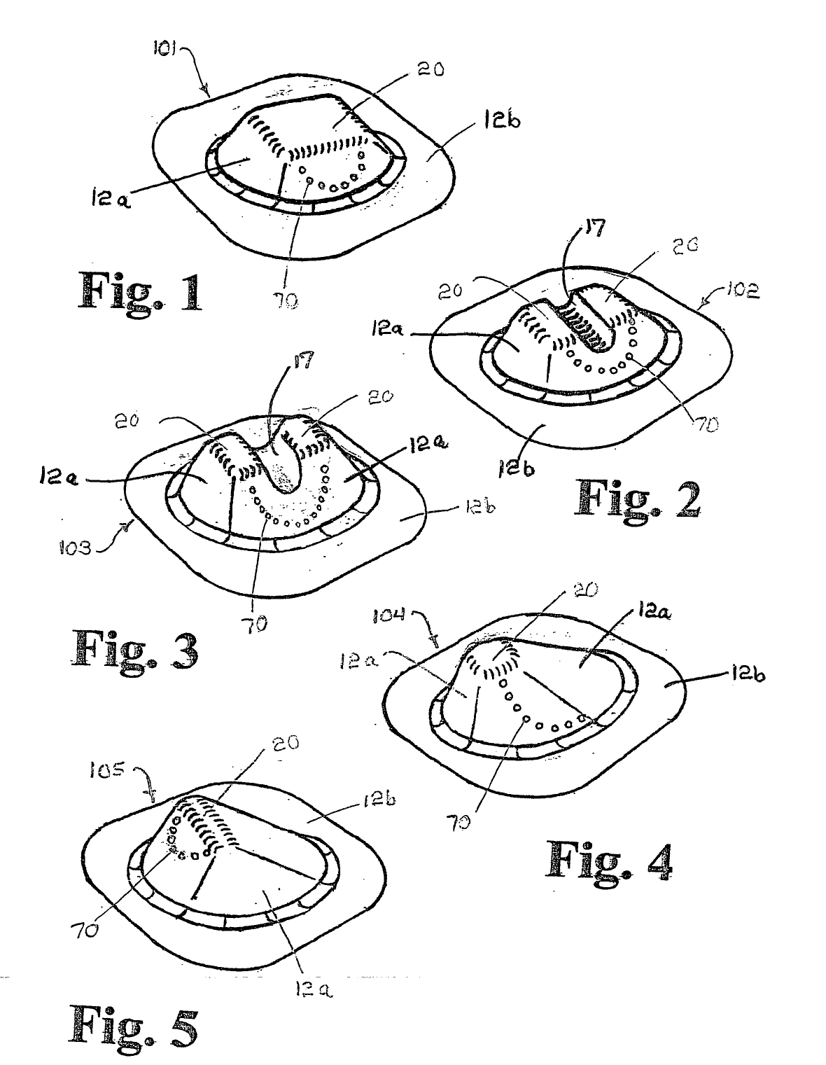

FIG. 1 generally shown at 101 represents a bilateral anterior three-dimensional rubber dam with a flat posterior inter-arch member 20. The short anterior to posterior dimension of the dam and the bilateral distribution of holes indicates that this anterior dam has been prepared to insolate anterior teeth-bilaterally back to the first premolars only. There is no integral flame attached to the exterior membrane 12. This dam, as intended of all dams shown in FIGS. 1 through 5 are to be attached to an external frame that is a separate device. In all these dams, the contoured portion of the rubber dam membrane 12a meets and merges with the flat, frontal planar membrane 12b, with intervening contour lines shown at the location where the contoured membrane meets the flat, planar membrane. In addition contour lines are located at the junction between the contoured membrane 12a and the flat or rounded posterior surface of the dams 20. This is true for all dams presented in this series of FIGS. 1-5. FIG. 2 generally shown at 102 is an anterior dam, like FIG. 1, but has a concave diaphragm 17 in the center of the otherwise flat posterior surface of the dam 20. This dam also isolates teeth in the anterior half of the alveolar arch. Note that both of these dams isolate teeth in the anterior half of the alveolar arch only and that there is an alternative design of either a flat posterior surface 20 or a posterior surface with a central concave diaphragm 17.

The concave diaphragm 17 for a posterior dam such as the one shown in FIG. 3, however, is absolutely essential, since the dam extends back beyond the division between the anterior and the posterior halves of the alveolar arch. Any posterior dam that seeks to isolate beyond the junction of the anterior and posterior halves of the alveolar arch must have a concave posterior diaphragm.

FIG. 3 generally shown at 103 is a bilateral posterior three-dimensional rubber dam that isolates an entire arch of teeth. This dam must have a concave posterior diaphragm 17 to prevent impingement of rubber dam material on the intra-alveolar space. Fourteen holes are provided in order to isolate up to a full arch of teeth.

FIG. 4 generally shown at 104 is an asymmetrical unilateral three-dimensional rubber dam. It extends all of the way posterior in a single arch on one side only. It can isolate up to an entire alveolar arch of teeth, but on a single side of the patient's mouth only. It can also be configured to isolate two quadrants of teeth, both located on a single side of the patient's mouth only, but in most cases, it is used to isolate a single quadrant of teeth at a time. The smaller inter-arch dimension of the posterior flat surface 20 of this dam and also the bilateral posterior dam FIG. 3, is consistent with the general rule of thumb that inter-occlusal distance decreases from front to back in the mouth. Note that the anterior dams in FIG. 1 and FIG. 2 have a much larger dimension for the flat inter-occlusal surfaces 20 of these dams since the inter-occlusal dimension increases toward the front of the mouth.

FIG. 5 generally shown at 105 is a bilateral wedge-shaped three-dimensional rubber dam can be used to isolate teeth bilaterally, as is shown in the pattern of holes prepared in the dam or alternatively can be applied to isolate both upper and lower teeth on a single side of a patient's mouth by orienting the dam so that the long dimension of the posterior surface 20 spans the inter-occlusal dimension between the upper and lower teeth.

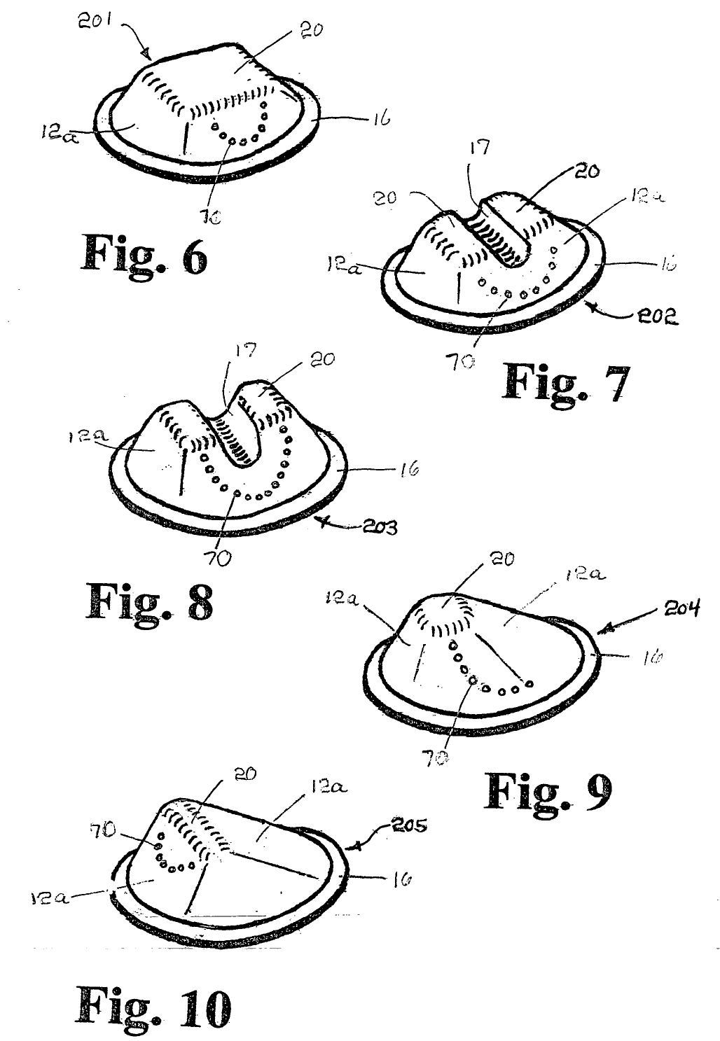

FIG. 6, FIG. 7, FIG. 8, FIG. 9, and FIG. 10, show 3-D dams that represent the same sequence of dams presented in FIGS. 1 through 5. These dams lack an extended frontal planar membrane 12b, but have an integrally attached frame 16 in the same frontal plane.

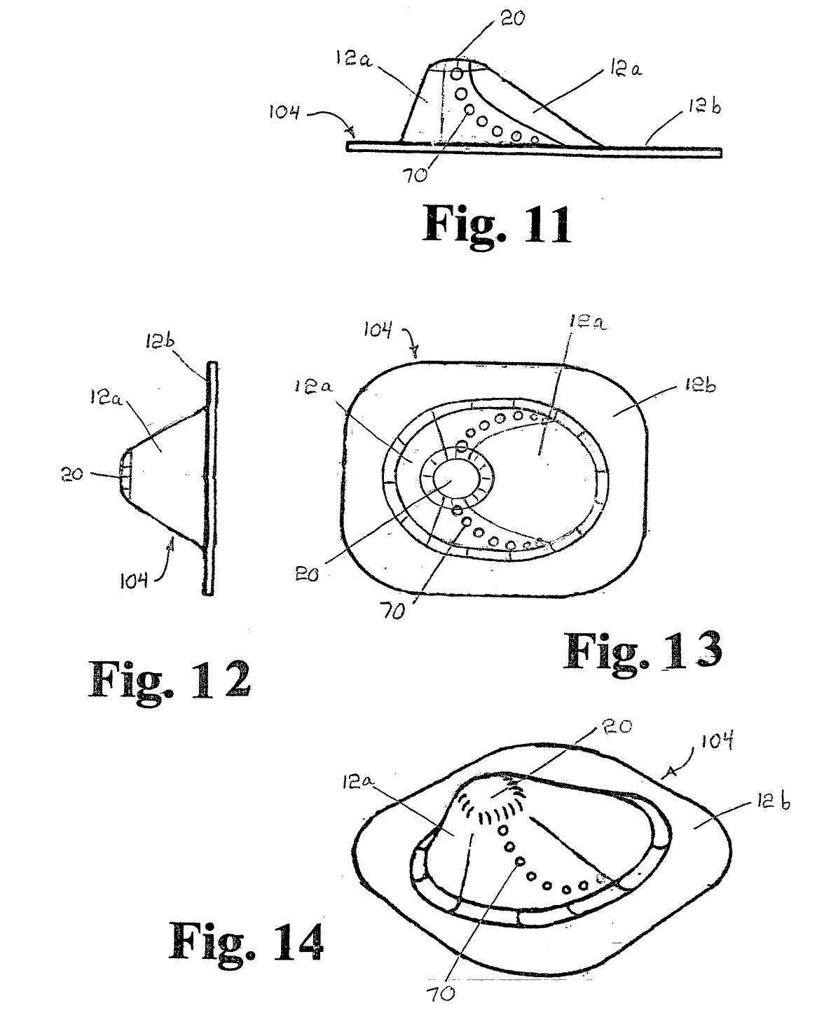

FIG. 11 is a side view of a unilateral three-dimensional rubber dam generally at 104. This form of dam is derived from the form that a unilateral conventional rubber dam takes on when it is stretched to its operational contours in the mouth to isolate teeth on a single side of the mouth only. This dam can be manufactured as a generally rounded (truncated) asymmetric conical form or a generally rounded (truncated) asymmetric pyramidal form or a generally rounded (truncated) asymmetric wedge-shaped form, or a generally rounded (truncated) asymmetric funnel-shaped form, a generally rounded (truncated) asymmetric tapering form, or a related composite form that is a mix of the previous mentioned forms.

FIG. 12 is an end view of the asymmetric unilateral dam configured with individual holes for conventional isolation

FIG. 13 is a top view of the asymmetric unilateral dam configured with individual holes for conventional isolation

FIG. 14 is an isometric view of the asymmetric unilateral dam configured with individual holes

FIGS. 11, 12, 13, and 14 all show the posterior inter-arch surface 20 that is rounded or flat with rounded corners, the three-dimensional formed portion of the rubber dam membrane 12a, the flat frontal planar membrane of the dam 12b, the individually prepared holes 70 of which there are seven on each side of the dam in order to isolate all of the teeth on one side of an arch or alternatively on both sides of the arch simultaneously (holes for the wisdom teeth are left out, but could be added by the end-user if so desired). Although this is the embodiment of the dam shown as illustrative of the general principles of construction of this dam, other embodiments of the same general dam have not been shown but have been described in the text.

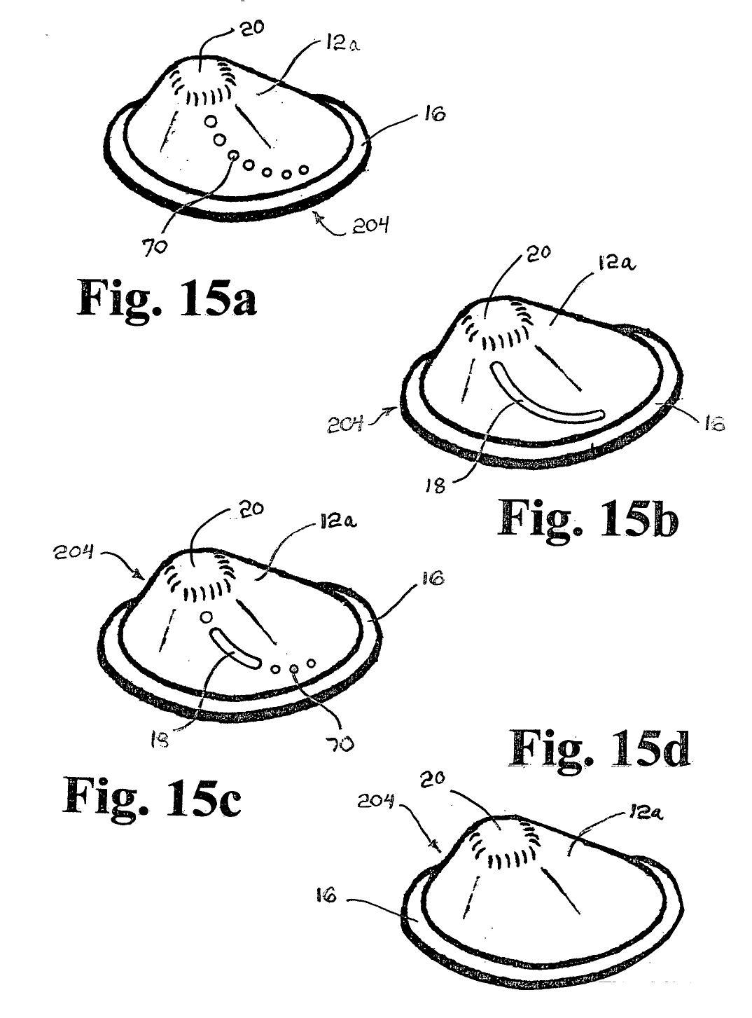

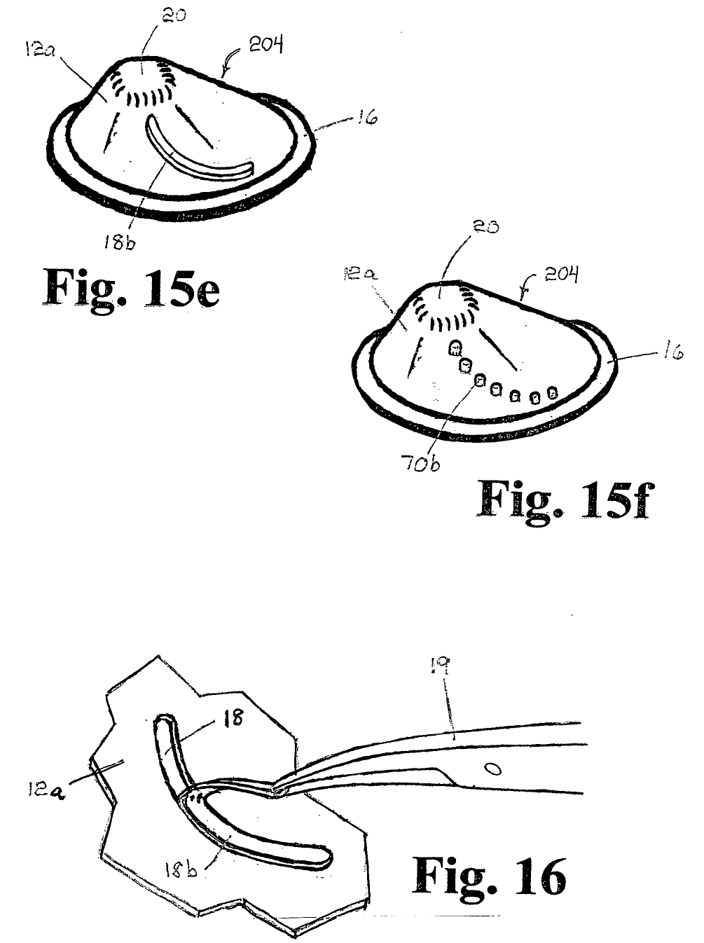

FIG. 15a shows a unilateral asymmetric dam configured with individual holes for conventional isolation of individual teeth, while FIG. 155b shows the same dam configured with a slit for general field isolation, FIG. 15c shows a dam configured with holes and a slit for hybrid isolation, FIG. 15d shows a solid membrane that the end-user may configures to custom fit an application, FIG. 15e shows the dam with a raised slit-like projection 18b to be removed to configure the dam for general field isolation, and FIG. 15f shows a series of raised individual projections that may be selectively removed to configure the dam for conventional isolation (note that FIG. 15e and FIG. 15f are merely different embodiments of unperforated membranes like the solid membrane dam).

FIG. 16 shows the removal of the raised slit-like projection 18b by tearing along a tear line 25 with a hemostat 19 to open a slit 18 in the rubber dam membrane

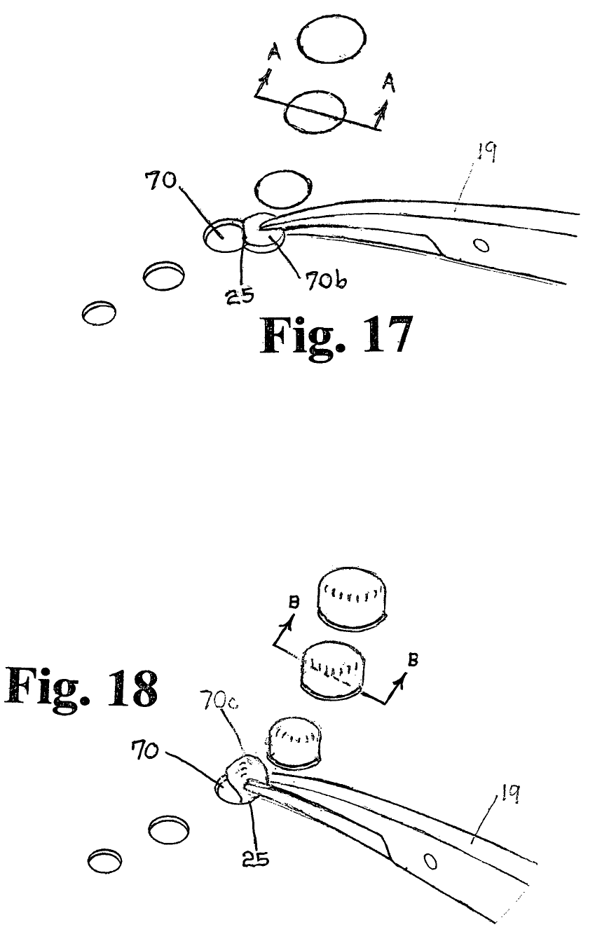

FIG. 17 shows the removal of a flat circular piece of rubber dam membrane 70b by tearing along a tear line 25 with a hemostat 19 to open a round hole 70 in the rubber dam membrane

FIG. 18 shows the removal of the raised cylindrical projection 70c by tearing along a tear line 25 with a hemostat 19 to open a round hole 70 in the rubber dam membrane

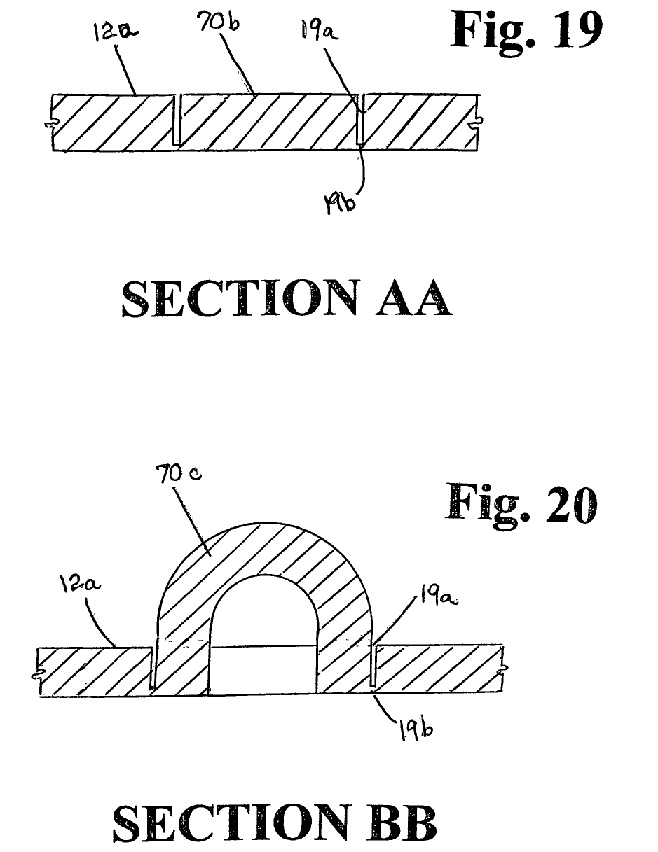

FIG. 19 shows section AA of FIG. 17 showing the circular piece of rubber dam material 70b, the recessed tear line 19a, the surrounding rubber dam membrane 12a, and the thin diaphragm of barrier material 19b that is torn during the detachment of the circular piece of rubber dam material 70b

FIG. 20 shows section BB of FIG. 18 FIG. 19 shows section AA of FIG. 17 showing the raised projection of rubber dam material 70c, the recessed tear line 19a, the surrounding rubber dam membrane 12a, and the thin diaphragm of barrier material 19b that is torn during the detachment of the raised projection 70c

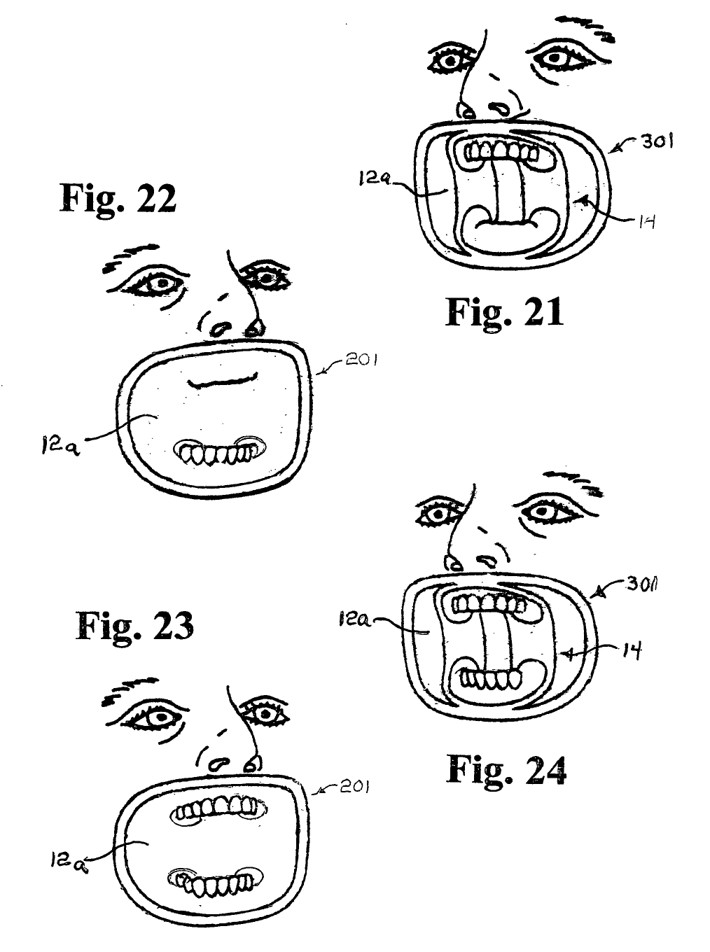

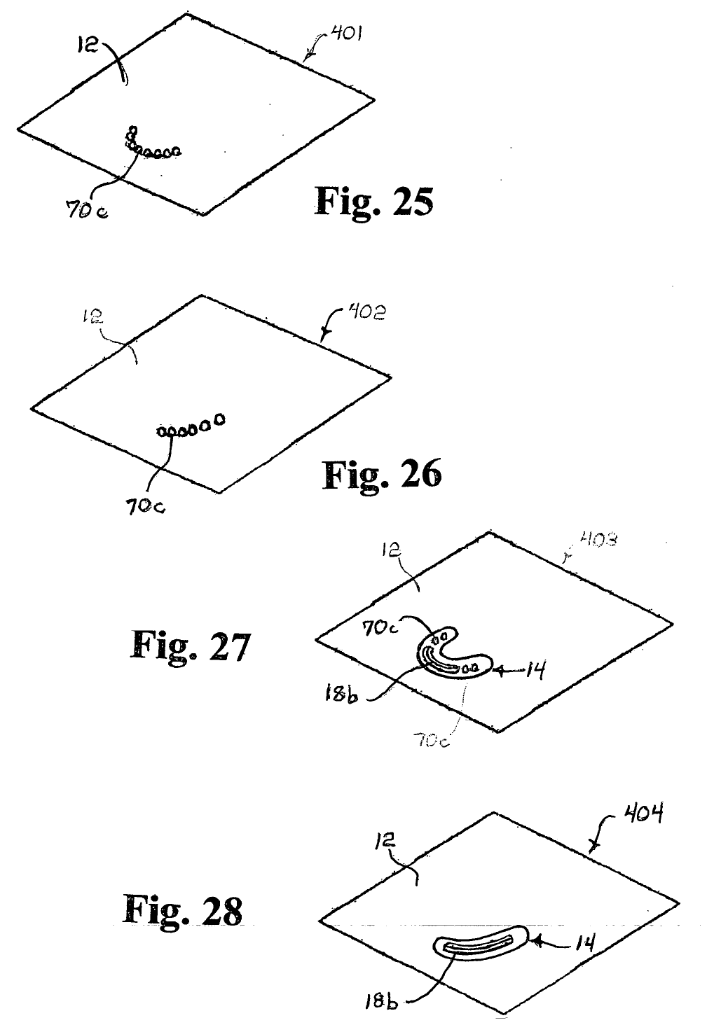

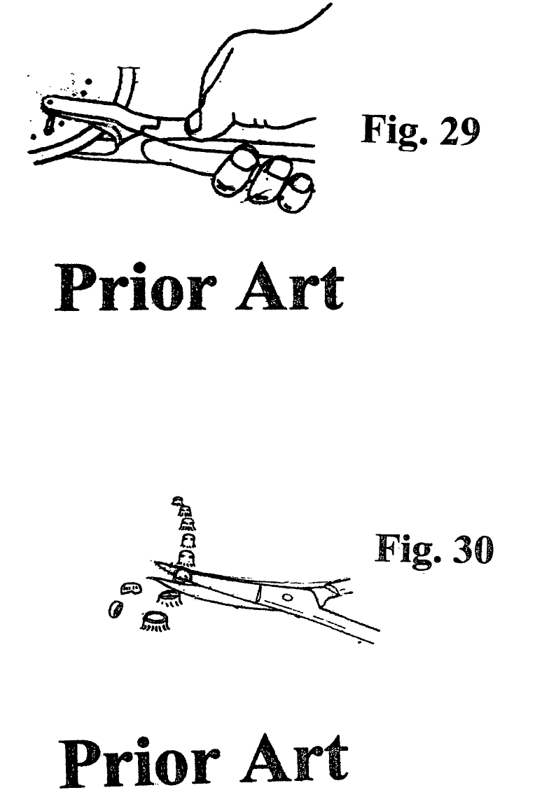

FIG. 21 shows a prior art method of punching holes in a rubber dam membrane with a rubber dam punch

FIG. 22 shows a prior art method of cutting raised projections in a rubber dam membrane with a scissors

### Prior Art Methods and Novel Methods of Preparing Three Dimensional Rubber Damns for Conventional and General Field Isolation

Prior Art Methods:

The formation of small circular holes for conventional isolation of the teeth in dentistry has been accomplished most frequently by punching holes 70 in a rubber dam membrane with a forceps like instrument called a rubber dam punch, as shown in FIG. 19. This forceps-like device operates much like a paper punch, punching a variety of different size holes in a membrane by the selection of different diameter circular holes on a mechanism called the anvil and bringing a conical male cutting member against the hole with a rubber dam membrane interposed between the male and female cutting members. Although the conventional rubber dam punch has exclusively punched varying sized holes for conventional isolation of the clinical crowns of teeth in dentistry, Heasley, the author of this patent application, has proposed the introduction of rubber dam punches that punch slits or both slits and holes for general field isolation purposes and hybrid isolation purposes as well (Heasley; U.S. patent application Ser. No. 10/334,943, Rubber Dam Punches that Punch Slits in Rubber Dam Membranes for General Field Isolation).

An alternative prior art method of preparing holes in a dental rubber dam membrane is the formation of a rubber dam with circular hollow projections in the membrane that can be cut off with a scissors as shown in FIG. 20. Cutting off the projection leaves a circular hole perforation, the location and diameter of which varies with the dimensions and location of the projection within the rubber dam membrane. A number of prior art authors have proposed this method, including Malmin.

Still another prior art method of preparing a rubber dam for clinical isolation is the manufacture of membranes with the circular holes, or slits, or other perforations already prepared in them during the manufacturing process. This method is especially useful in general field isolation of whole groups of teeth and alveolar tissues simultaneously.

Heasley, the author of this disclosure, has proposed the formation of open slits in general field isolation membranes of all types (U.S. patent application Ser. No. 10/117,395) and has also proposed the use of an altered rubber dam punch that has the capacity to punch slits in rubber dams as a method to lengthen slits that have already been provided in a general field isolation rubber dam.

Detachment of Membrane Material Along Prepared Tear Lines:

An innovative method of manufacturing rubber dams with pre-formed recesses in the dam facilitates the tearing of the rubber dam material to form openings. Controlled shearing of the rubber dam membrane by exceeding its elastic and plastic limit to the point of tearing along a predetermined tear line to form holes or other shapes of perforations in rubber dam membranes has not been reported in the dental literature. The novel method of designing and manufacturing rubber dams with recessed tear lines integrated into the membrane allows a clinician to easily create openings for a proposed operating site. A predictable geometric shape may be removed by propagation of the tearing along a tear line that guides detachment of a piece of membrane being removed. The piece of rubber dam material to be removed may be manufactured flat and flush with the thickness of the membrane, except where the indentation of the tear line is located or alternatively may be a raised tab or thickened piece of material or a projection that can be more easily grasped with an instrument such as a forceps, cotton pliers, or hemostat.

An opening in a rubber dam can be customized to fit the operating site that the dentist intends on isolating by opening some holes or perforations required for the application, while leaving other pieces of rubber dam membrane with prepared tear lines intact. While the most widely utilized membrane material in the prior art has historically been latex or latex derivatives, other elastomers have been introduced to manufacture rubber dams due to the high degree of allergenicity of latex to the general population. The rubber dam devices of the future will be manufactured from elastomers with a high percentage of elongation such as latex, latex derivatives and analogs, nitrile, vinyl, silicone, polyurethane, and other elastomers and polymers, and also from a variety of materials with a low percentage of elongation such as malleable foils, plastics, composite materials, mylar, and even paper or cardboard treated with substances for water resistance. The physical properties of these materials vary substantially and new methods of manipulating different types of barrier membrane materials will accompany the introduction of new materials.

With this method, a perforation is first initiated by piercing the rubber dam along a prepared tear line. The controlled tearing of the membrane from the point of initiation of the tear and along the tear line creates the perforation in the dam and the removal of a piece of rubber dam material of predetermined size and location from the membrane. A variety of methods may be employed to initiate a tear and cause the tear to propagate along the rubber dam membrane in a controlled manner to prepare an opening in a rubber dam. The clinician is not limited to the use of any single instrument to customize a rubber dam. Initiation of the controlled tear may be made by grasping raised projections with a hemostat or cotton pliers or tweezers, or other instrument. Alternatively, a controlled tear can be initiated by piercing the rubber dam with an appropriate small hand instrument and then removing the ‘hanging chad’ with a cotton pliers or even a fingernail. Easier manipulation of the rubber dam membrane will make the device more predictable as an isolation tool and more convenient to apply by clinicians and auxiliary personnel.

Both dental and medical applications of rubber dam will benefit from the manufacture of dams with prepared tear-lines. Although three-dimensional rubber dams are presented as exemplary types of rubber dams with prepared tear lines allowing detachment of sections of rubber dam membrane, these methods also apply to all types or rubber dam, including flat dams, rubber dams with operative inserts and without operative inserts, dams made of non-conventional materials of all types, including malleable foils, plastics, composites, paper, and cardboard.

A tear line is an indentation in a membrane with residual material of minimal thickness of rubber dam material manufactured adjacent a normal thickness rubber dam membrane. By reducing the thickness of the barrier material to a minimal thickness, controlled shearing propagates along the recessed indentation in the dam. The minimal thickness portion of rubber dam material left in place may have a continuous layer of material or may alternatively be further perforated with minute holes or openings to ease the amount of force and effort to tear the material. This method is quite novel and has not been implemented in rubber dam prior art.

Although the invention has been described with respect to preferred embodiments thereof, it is to be understood that changes and modifications may be made therein which are within the full intended scope of this invention as defined by the appended claims. Any embodiment described in the text of the disclosure but not graphically depicted should be fully considered to be within the spirit and scope of the disclosure. The general principles of construction or methods of application of the dams described and depicted are illustrative of the basic principles of isolation with rubber dams of the parent disclosure as well as this continuation-in-part disclosure. Merely listing steps of a method in an alternative manner or leaving out or adding a step specified in a method of usage does not constitute a change in novelty. A simple change of orientation of an isolation device having the same principles of intra-oral anatomical interaction and equivalent elements of construction shall be considered as being within the spirit and scope of the invention. The foregoing description and drawings merely explain and illustrate the principles of the invention, but the invention is not limited thereto, except in so far as the claims are limited. Those skilled in the art of dentistry will recognize obvious potential modifications and variations therein which are within the spirit and scope of the invention, but such modifications shall not constitute a change of novelty.

1. rubber dams with pre-formed recesses or indentation in a barrier membrane that facilitate the detachment of a predetermined geometric piece of rubber dam material by controlled tearing of the membrane in order to creating openings in the membrane for the isolation of a medical operating site.

2. the rubber dams of claim 1, wherein the rubber dam is a dental dam that is configured to isolate a dental operating site by detaching circular pieces of the barrier membrane or elongated slits or alternatively both small holes and slits simultaneously by controlled tearing along a tear line or indentation line

3. the dental rubber dams of claim 2, wherein the dams are three-dimensional dental dams generally comprised of forms that are derived from the general contours, proportions, and dimensions of a conventional rubber dam stretched to its operational contours when it is actively applied to a patient's mouth during dental treatment procedures.

4. dental rubber dams, wherein the dams are three-dimensional dental dams generally comprised of forms that are derived from the general contours, proportions, and dimensions of a conventional rubber dam stretched to its operational contours when it is actively applied to a patient's mouth during dental treatment procedures.

5. the three-dimensional dental rubber dams of claim 4 wherein the dam is comprised of a form formed in a mold or die or forming tool which is comprised of a generally rounded, truncated wedge form, or a generally rounded truncated pyramidal form, or a generally rounded truncated conical form, or a generally rounded truncated funnel form, or a generally rounded truncated semi-round tapering form, or a form that is a composite or equivalent of these forms.

6. a three-dimensional rubber dam of claim 4, wherein the rubber dam form is derived from a bilateral application in which teeth are isolated on both sides of an alveolar arch imparting a form to the dam that is generally symmetrical about a plane of symmetry within the dam that aligns with and is coincidental to the patient's mid-saggital plane when the rubber dam is applied to the mouth of a patient

7. a three-dimensional rubber dam of claim 4, wherein the rubber dam form is derived from a unilateral application in which teeth are isolated on one side of an alveolar arch only and the dam is generally asymmetrically disposed about a midline plane that aligns with and is coincidental to the patient's mid-saggital plane when the rubber dam is applied to the mouth of the patient; the general form of the dam being also disposed asymmetrically with respect to the frontal plane of the of the dam and non-perpendicularly thereto.

8. the three-dimensional dental rubber dams of claim 6, wherein select bilateral rubber dams that isolate posterior teeth on both sides simultaneously that would otherwise impinge upon the intra-alveolar space are comprised of a concave posterior diaphragm to prevent impingement of the dam on the patient's intra-alveolar space, tongue, and soft palate, thereby preventing the patient from gagging, choking, and ultimately rejecting the dam

9. a unilateral three-dimensional rubber dam according to claim 7, wherein the dam is designed in the manner of a generally rounded truncated wedge form, and comprises a circular rim around the dam, the general form of the dam being disposed asymmetrically with respect to the plane of the rim and non-perpendicularly thereto.

10. the rubber dam according to claim 7, wherein the dam is designed in the manner of a generally rounded truncated conical form, and comprises a circular rim around the dam, the general form of the dam being disposed asymmetrically with respect to the plane of the rim and non-perpendicularly thereto.

11. the rubber dam according to claim 7, wherein the dam is designed in the manner of a generally rounded truncated pyramidal form, and comprises a circular rim around the dam, the general form of the dam being disposed asymmetrically with respect to the plane of the rim and non-perpendicularly thereto.

12. the rubber dam according to claim 7, wherein the dam is designed in the manner of a generally rounded truncated tapering form, and comprises a circular rim around the dam, the general form of the dam being disposed asymmetrically with respect to the plane of the rim and non-perpendicularly thereto.

13. a rubber dam according to claim 7, wherein the dam is designed in the manner of a tapering bag and comprises a circular rim around the bag, the bag being disposed asymmetrically with respect to the plane of the rim and non-perpendicularly thereto.

14. the rubber dam according to claims 9, 10, 11, 12, and 13, wherein the dam is designed in the same manner of the dams of claims 9-13, but does not comprise a circular rim around the dam, thereby lacking an integrally attached frame, but having a frontal plane of barrier membrane composing the front of the dam; the general form of the dam being disposed asymmetrically with respect to the center of the body of the dam and non-perpendicularly to the frontal plane barrier membrane of the dam

15. the bilateral rubber dams according to claim 6, wherein the dam is designed in a manner symmetrically disposed about a plane that is coincidental to the patient's mid-saggital plane when the rubber dam is applied to the mouth of the patient; and additionally, the general form of the dam being disposed symmetrically with respect to the frontal plane of the dam and perpendicularly thereto.

16. the bilateral rubber dams of claim 15, wherein the form of the dam may be comprised of a generally rounded, truncated wedge form, a generally rounded truncated pyramidal form, a generally rounded conical form, a generally rounded truncated funnel form, a truncated semi-rounded tapering form, or a composite or equivalent of the forms stated.

17. the three-dimensional rubber dams of claim 4, wherein the dams have an integrally attached exterior frame

18. the three-dimensional rubber dams of claim 4, wherein the dams are stretched or otherwise attached to an exterior frame that is a separate device.

19. the three-dimensional rubber dams of claim 4, wherein the dams may be configured or prepared at the time of their manufacture with holes only for conventional isolation of teeth, or alternatively with slits for general field isolation of teeth and soft tissue, or alternatively with holes and slits simultaneously for a hybrid approach to isolation of teeth and soft tissues

20. the method of an end-user preparing a three-dimensional rubber dam with an un-perforated membrane for alternative methods of isolation, comprising the alternative techniques of:
(a) punching, cutting, tearing, detaching, or otherwise removing small circular pieces of barrier material to form appropriately sized holes at locations where teeth will be brought through the membrane
(b) punching, cutting, tearing, detaching, or otherwise removing an elongated piece of barrier material to form a slit at a location where a group of teeth and tissues will be brought through the membrane
(c) punching, cutting, tearing, detaching, or otherwise removing small circular pieces and an elongated piece of barrier material to form appropriately sized holes and a slit where individual teeth and groups of teeth and tissues will be brought through the membrane

21. the three-dimensional rubber dams of claim 1, wherein the rubber dam membrane may either be composed of a natural or synthetic polymeric elastomer with a high percentage of elongation such as latex or a latex analog or nitrile or polyurethane or vinyl or silicone or other elastomer or alternatively may be composed of alternative materials that have a low percentage of elongation such as mylar, plastic, composite materials, or malleable metals such as, but not limited to, aluminum, or alloys of variable composition having desirable properties for clinical isolation purposes

22. three-dimensional rubber dams that isolate either an operating site in at least a portion of a single alveolar arch or alternatively isolate operating sites in portions of both alveolar arches simultaneously
